(19) United States
(12) Patent Application Publication
(10) Pub. No.: US 2021/0347065 A1
(43) Pub. Date: Nov. 11, 2021

(54) Reciprocating knife assembly

(71) Applicants: Greg Dickinson, Brigham City, UT (US); Lance Dickinson, Syracuse, UT (US)

(72) Inventors: Greg Dickinson, Brigham City, UT (US); Lance Dickinson, Syracuse, UT (US)

(21) Appl. No.: 16/867,709

(22) Filed: May 6, 2020

(51) Int. Cl. B26B 1/08

(52) U.S. Cl. CPC B26B 1/08

(57) ABSTRACT

The present invention is directed to a reciprocating culinary knife assembly. The assembly is battery operated and operates a steak knife in reciprocating fashion. An ergonomic oversized handle portion is designed for users with arthritis or other debilitating conditions that render handling small implement difficult. A single removable battery pack is contained within a battery receiving chamber formed at one end of the housing for the assembly, the pack designed for easy snap fit within the chamber. The housing is made of a rigid material which is covered with a pliable material such as rubber or silicon to enhance gripping and further reduce discomfort. A pressure sensing mechanism operates as an on/off switch to enhance user safety.

### FIELD OF THE INVENTION

The present invention relates generally to cutting tools. More particularly, the invention relates to a reciprocating culinary knife.

### BACKGROUND OF THE INVENTION

Electric carving knives have been around for many years. Most are large chef or culinary knives that are connected to a source of AC power. While generally satisfactory for their intended purpose, these implements suffer from some drawbacks. First, the handles tend to have a very small circumference, even if they are considered “ergonomic”. While this may be satisfactory for many users, people with arthritis or other conditions find it difficult to control such knives. Also, the handle portion tends to be made from rigid materials which can also be uncomfortable for people with musculoskeletal issues. Finally, the battery powered knives tend to have several batteries which are packed end to end in an elongated battery receiving chamber making battery replacement tedious.

### SUMMARY OF THE INVENTION

The present invention is directed to a reciprocating culinary knife assembly. The assembly is battery operated and operates a steak knife in reciprocating fashion. An ergonomic oversized handle portion is designed for users with arthritis or other debilitating conditions that render handling small implements difficult. A single removable battery pack is contained within a battery receiving chamber formed at one end of the housing for the assembly, the pack designed for easy snap fit within the chamber. The housing is made of a rigid material which is covered with a pliable material such as rubber or silicon to enhance gripping and further reduce discomfort. A pressure sensing mechanism operates as an on/off switch to enhance user safety.

It is a major object of the invention to provide an improved reciprocating knife assembly.

It is another object of the invention to provide an improved battery powered knife assembly.

It is another object of the invention to provide an improved battery powered knife assembly having an ergonomic handle.

It is another object of the invention to provide an improved battery powered knife assembly having an oversized handle.

It is another object of the invention to provide an improved battery powered knife assembly having a slide out battery pack.

It is another object of the invention to provide an improved battery powered knife assembly having a finger guard.

It is another object of the invention to provide an improved battery powered knife assembly having a pressure sensing means for controlling actuation.

### BRIEF DESCRIPTION OF THE DRAWINGS

FIG. 1 shows a side perspective view of the reciprocating knife assembly of the invention.

FIG. 2 shows a perspective view of the mechanism of the reciprocating knife assembly of the invention.

FIG. 3 shows a front perspective view of the reciprocating knife assembly of the invention.

FIG. 4 shows a perspective view of the mechanism of the reciprocating knife assembly of the invention.

### DETAILED DESCRIPTION

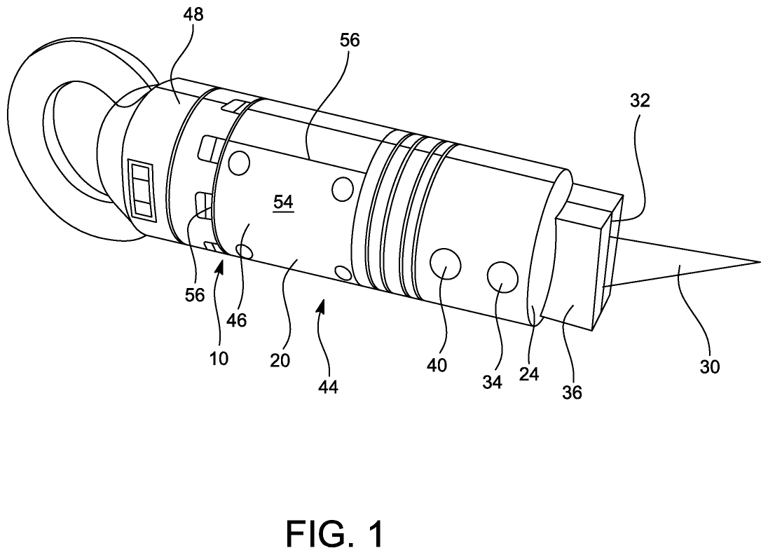

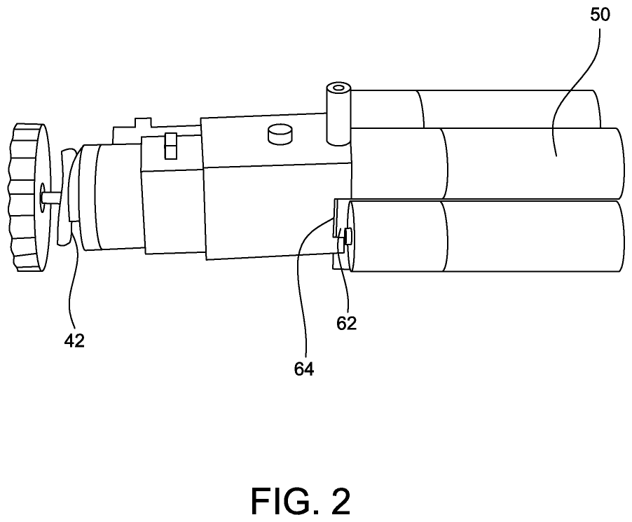

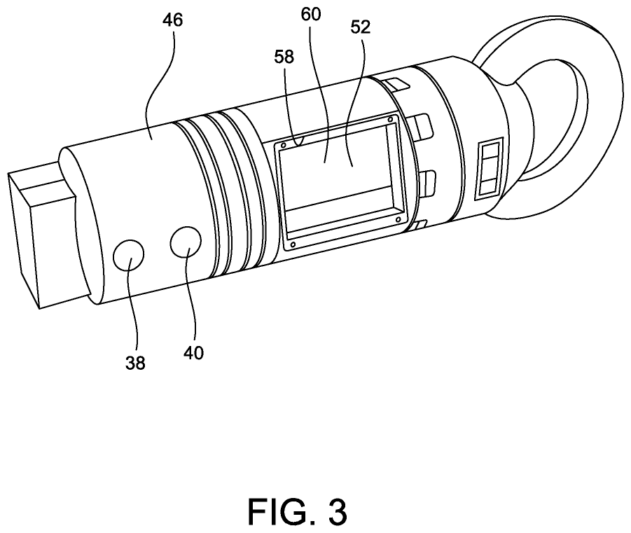

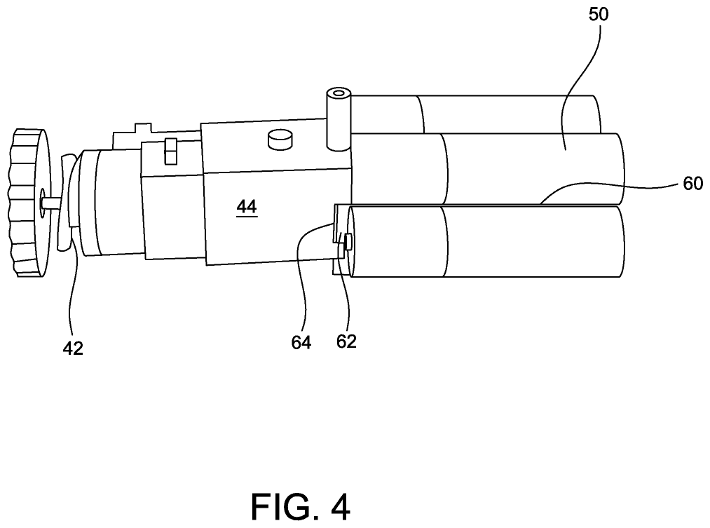

The present invention is directed to a reciprocating knife assembly, generally indicated by the numeral 10. The assembly 10 is intended primarily for use by persons with grasping issues such as arthritis and is preferably sized as a steak knife, but the concept of the invention may be extended to any culinary knife or reciprocating saw. Referring now to FIGS. 1-4, the housing 20 for the assembly 10 is “oversized” in that the handle portion is oversized relative to a standard steak knife handle or grip. This large size makes grasping easier for people with grasping issues. The inventive knife is designed for operation with four AA size batteries, and the interior of the oversized housing 20 must have a large enough diameter to accommodate the batteries arranged in parallel. The front 22 of the housing includes a substantially circular finger/hand guard 24. While some prior art culinary knives have hand guards, they are generally on the lower half of the housing or handle as this is where the blade is located. The finger/hand guard encircles the entire housing to prevent the user's hand from slipping off of the knife with the application of forward pressure or movement, a common occurrence for persons with weakened hand musculature. Also, the finger/hand guard 24 serves as an abutment surface for the user's hand to allow for the application of more forward pressure.

The blade 30, which is preferably serrated, is releasably attached within attachment slot 32, the release mechanism operated by a pushbutton 34 located on the side of the housing 20. The attachment slot 32 is situated in a forwardly extended portion 36 of the housing 10, the extended portion 36 positioning the blade 30 forward of the user's hand. An on/off switch 40 is positioned next to pushbutton 34 and serves to apply electrical power to the reciprocating mechanism. A key aspect of the invention is that the knife assembly 10 can be actuated without continually depressing an activating switch. This is accomplished by a pressure sensing mechanism 42 situated inside of compartment 44. The pressure sensing mechanism 42 is a micro-switch which is positioned to sense when pressure is applied to the blade as would be apparent to one of skill in the art. When a user positions the blade 30 in contact with the food item to be cut, and the power is switched on via switch 40, the mechanism 42 actuates the reciprocating motion. When the blade 30 is removed from the food item actuation ceases. The knife 10 will not operate unless there is pressure sensed by micro-switch 42 and switch 40 is in the on position. This operation, in combination with the ergonomic handle portion 46, allows for nearly effortless use of the assembly. The ergonomic handle portion 46 is preferably covered with a compressible material 48 such as silicone rubber of equivalent, the material 48 may be textured to improve grip as is known in the art. While shown as cylindrical, the handle portion 46 may be tapered with the larger diameter portion toward the rear of the handle 46. This configuration would cause the user's hand to slide toward hand guard 24, which allows the fingers to work together in contrast to prior art handles with finger indents. In lieu of the pressure sensing mechanism, hand guard 24 can include a switch so that forward pressure on the hand guard can be used to actuate the blade 30.

Power for the assembly 10 is provided by way of battery pack 50. A battery receiving chamber 52 formed within the housing 20 is sized to receive the battery pack. Chamber 52 is enclosed by a removable panel 54 via interlocking tabs 56 and slots 58 in the well known manner. In the example shown, the battery pack 50 comprises a receptacle 60 for containing the individual batteries, the batteries electrically connected to a contact portion 62 of the receptacle 60. The batteries 50 are arranged in parallel so that a minimum inner diameter of the housing 20 is established, and correspondingly the ergonomic, oversized outer diameter of the housing. Contact portion 62 is sized for sliding engagement within a slot 64 formed in the compartment 44 so as to provide electrical power to the reciprocating mechanism.

In operation, the user grasps the housing 20, with hand about the ergonomic portion 46 of the housing. The user then positions the blade 30 on the food item to be cut which initiates actuation of the reciprocating mechanism as discussed above. For users with grasping issues, the tendency is for the hand to slide forward and engage guard 24. When finished, the user simply removes the blade 30 from the food item to shut off the mechanism.

1. A reciprocating culinary knife assembly comprising:
a substantially cylindrical housing having a handle portion;
a cutting blade connected within and extending forwardly from said housing;
a reciprocating assembly within said housing for causing reciprocating motion of said blade;
a pressure sensing mechanism within said reciprocating assembly for sensing contact of said blade with a food item;
a substantially circular hand guard positioned at a forward end of said housing;
whereby, using said hand guard as an abutment member, a user may initiate operation of said reciprocating assembly by contacting and applying pressure to said food item.

2. The knife of claim 1 wherein operation of said reciprocating assembly is ceased upon cessation of pressure to said food item.

3. The knife of claim 1 wherein said housing has a larger diameter rear portion.

4. The knife of claim 1 wherein said housing is covered in a compressible material.

5. The knife of claim 1 wherein said housing has an inner diameter sized to accommodate 4 AA sized batteries connected in parallel.
